(19) United States
(12) Patent Application Publication
(10) Pub. No.: US 2015/0004928 A1
(43) Pub. Date: Jan. 1, 2015

(54) GROUP DATA PLAN QUOTA ALLOCATION FOR MOBILE DEVICES

(71) Applicant: Alcatel-Lucent USA Inc., Murray Hill, NJ (US)

(72) Inventors: Yigal Bejerano, Springfield, NJ (US); Daniel Andrews, Chatham, NJ (US); Pramod Koppol, Manalapan, NJ (US)

(73) Assignee: Alcatel-Lucent USA Inc., Murray Hill, NJ (US)

(21) Appl. No.: 13/932,256

(22) Filed: Jul. 1, 2013

(51) Int. Cl. H04M 15/00

(52) U.S. Cl. CPC H04M 15/781; H04M 15/765
USPC 455/405

(57) ABSTRACT

A group server maintains an outstanding quota granted to a group of lines at a variable margin at at most a maximum total standby allocation to ensure a group data usage of the group surpasses a current notification milestone by at most an accuracy requirement associated with the current notification milestone, the group server including a processor configured to update a tally of the group data usage based on usage update messages, allocate, to lines requesting a new quota allocation, a current quota of a plurality of quotas associated with the current notification milestone, in response to the tally of the group data usage plus the outstanding quota being within the variable margin, and allocate, to lines requesting a new quota allocation, a next quota of the plurality of quotas, in response to the tally of the group data usage plus the outstanding quota exceeding the variable margin.

### FIELD OF THE INVENTION

The invention is related to the field of communication systems and in particular to managing resource allocation to subscribers.

### BACKGROUND OF THE INVENTION

Diameter Credit-Control Application (DCAA), is a networking protocol used to implement real-time credit control over service units used for a variety of end user services that are purchased by subscriber lines of a network provider for use by a user equipment (UE) associated with the subscriber line. These service units may be used to oversee an amount of uploaded or downloaded data by the UE. A line server is connected to the UE via a gateway and is used to manage the real-time credit-control of a particular subscriber (herein known as a “line”). The communication between the line server and the gateway may be based on the Diameter protocol standardized in IETF RFC 4006.

At the start of a subscriber session, and during the session, the line requests service units via a Credit Control Request (CCR) message sent between a gateway and the line server, and the line server may grant service units to the line or reject the request from the line via a Credit Control Answer (CCA) message sent between the line server and the gateway.

Further, during the session, the line server may send a Re-Authorization Request (RAR) message to the line to request reauthorization of the line. The line responds to the RAR message by sending a Re-Authentication Answer (RAA) message followed by a CCR message to the line server.

Recently, many network providers offer data services to a plurality of UEs that are joined together in a user group, for example, as a “family”. A group server may be used to manage the real-time credit-control over a plurality of the line servers that form a user group.

The group server may allocate a fixed amount of service units to each of the lines within the group in what is known as an “off-line system”. Alternatively, the group server may allocate service units to the group such that only a fraction of the full allowance amount of service units for the group is assigned to the group of lines. By providing the group with only a fraction of the full allowance of service units, rather than equally dividing the full group allowance among the lines, lines within the group that consume different amounts of service units can be allocated additional resources. This may more efficiently allocate the service unit resources when compared to allocating a fixed number of service units to each line in the off-line system.

Conventionally, each time the group consumes the fractional allocation of service units currently allotted to the group, a session update must be performed to reallocate quotas to each of the lines of the group. To perform the session update, RAR/RAA message pairs must be communicated between each of the lines of the group and the group server to force the lines to request new quotas, and, thereafter, CCR/CCA message pairs must be communicated to assign the new quota to each of the lines of the group.

### SUMMARY OF THE INVENTION

As the size of the user group grows, the amount of messages required to complete the conventional session update process described above may significantly affect network performance.

Embodiments described herein relate to a group server configured to maintain an outstanding quota granted to a group of lines below a maximum total standby allocation, an online charging system and/or method configured to perform the same.

At least one example embodiment relates to a group server.

In one embodiment, the group server is configured to maintain an outstanding quota granted to a group of lines at a variable margin at at most a maximum total standby allocation to ensure a group data usage of the group surpasses a current notification milestone by at most an accuracy requirement associated with the current notification milestone. The group server including a processor configured to, update a tally of the group data usage based on usage update messages, allocate, to lines within the group requesting a new quota allocation, a current quota of a plurality of quotas associated with the current notification milestone, in response to the tally of the group data usage plus the outstanding quota being within the variable margin, and allocate, to lines within the group requesting a new quota allocation, a next quota of the plurality of quotas, in response to the tally of the group data usage plus the outstanding quota exceeding the variable margin.

In one embodiment, the processor allocates the current quota and the next quota passively without forcing the lines to renegotiate their respective quotas, in response to the group data usage being within the current notification milestone.

In one embodiment, the group server further includes a receiver configured to receive the usage update messages; and a transmitter configured to transmit instructions regarding quota allocation.

In one embodiment, the next quota is smaller than the current quota.

In one embodiment, the processor is further configured to, determine if the group data usage exceeds the current notification milestone; and reset the current quota for the group to a first quota of a plurality of quotas associated with a next notification milestone, in response to the group data usage being determined to have exceeded the current notification milestone.

In one embodiment, when the processor determines that the group data usage is within the current notification milestone then the processor is further configured to, determine if the outstanding quota is greater than the variable margin; and instruct a transmitter to transmit a message indicating that allocation of the current quota associated with the current notification milestone should be maintained, in response to the outstanding quota being determined to be within the variable margin.

In one embodiment, when the processor determines that the group data usage is within the current notification milestone then the processor is further configured to, determine if the outstanding quota is greater than the variable margin; and in response to the outstanding quota being determined to be greater than the variable margin, determine if any of the lines in the group of lines are associated with a previous quota of the plurality of quotas associated with the current notification milestone, transmit a message instructing assignment of the next quota of the plurality of quotas associated with the current notification milestone, in response to determining that all of the lines are associated with the current quota, the next quota being smaller than the current quota, and transmit a message instructing that one or more of the lines associated with the previous quota should renegotiate their respective quotas to the current quota, in response to determining that there are lines associated with the previous quota.

In one embodiment, the processor is further configured to vary the variable margin such that an amount the variable margin is below the maximum total standby allocation decreases for each consecutive quota allocation from the plurality of quota.

At least one example embodiment relates to a method of maintaining, by a group server, an outstanding quota granted to a group of lines at a variable margin at at most a maximum total standby allocation to ensure a group data usage of the group surpasses a current notification milestone by at most an accuracy requirement associated with the current notification milestone, the group of lines connected to the group server via a line server.

In one embodiment, the method includes updating a tally of the group data usage based on the usage update message; allocating, to lines within the group requesting a new quota allocation, a current quota of a plurality of quotas associated with the current notification milestone, in response to the tally of the group data usage plus the outstanding quota being within the variable margin; and allocating, to lines within the group requesting a new quota allocation, a next quota of the plurality of quotas, in response to the tally of the group data usage plus the outstanding quota exceeding the variable margin.

In one embodiment, the next quota is smaller than the current quota.

In one embodiment, the method further includes determining if the group data usage exceeds the notification milestone; and resetting the current quota for the group to a first quota of a plurality of quotas associated with a next notification milestone, in response to the group data usage being determined to have exceeded the current notification milestone.

In one embodiment, when the determining determines that the group data usage is within the notification milestone, then the method further includes determining if the outstanding quota is greater than the variable margin; and transmitting a message indicating that allocation of the current quota associated with the current notification milestone should be maintained, in response to the outstanding quota being determined to be within the variable margin.

In one embodiment, when the determining determines that the group data usage is within the notification milestone, then the method further includes determining if the outstanding quota is greater than the variable margin; and in response to the outstanding quota being determined to be greater than the variable margin then, determining if any of the lines in the group of lines are associated with a previous quota of the plurality of quotas associated with the current notification milestone, transmitting a message instructing assignment of the next quota of the plurality of quotas associated with the current notification milestone, in response to determining that all of the lines are associated with the current quota, the next quota being smaller than the current quota, and transmitting a message instructing that one or more of the lines associated with the previous quota should renegotiate their respective quotas to the current quota, in response to determining that there are lines associated with the previous quota.

In one embodiment, the method further includes varying the variable margin such that an amount the variable margin is below the maximum total standby allocation decreases for each consecutive quota allocation from the plurality of quota.

At least one example embodiment relates to a system to manage quota allocation.

In one embodiment, the system includes a group server and one or more line servers. The group server configured to maintain an outstanding quota granted to a group of lines at a variable margin at at most a maximum total standby allocation to ensure a group data usage of the group surpasses a current notification milestone by at most an accuracy requirement associated with the current notification milestone. The group server includes a group processor configured to, update a tally of the group data usage based on usage update messages received from the line servers, and instruct the line servers to allocate an assigned quota to lines within the group requesting a new quota allocation, the assigned quota being a current quota of a plurality of quotas associated with the current notification milestone in response to the tally of the group data usage plus the outstanding quota being within the variable margin, and the assigned quota being a next quota of the plurality of quotas in response to the tally of the group data usage plus the outstanding quota exceeding the variable margin. The one or more line servers configured to service the lines, each line server including a line processor configured to allocate the assigned quota to the lines within the group requesting the new quota allocation.

In one embodiment, the group processor is further configured to, determine if the group data usage exceeds the notification milestone; and reset the current quota for the group to a first quota of a plurality of quotas associated with a next notification milestone, if the group data usage exceeds the current notification milestone.

In one embodiment, when the group processor determines that the group data usage is within the notification milestone then the group processor is further configured to, determine if the outstanding quota is greater than the variable margin; and transmit a message to the one or more line servers indicating that allocation of the current quota associated with the current notification milestone should be maintained, if the outstanding quota is determined to be within the variable margin.

In one embodiment, when the group processor determines that the group data usage is within the notification milestone then the group processor is further configured to, determine if the outstanding quota is greater than the variable margin; and if the outstanding quota is determined to be greater than the variable margin then the group processor is configured to, determine if any of the lines in the group of lines are associated with a previous quota of the plurality of quotas associated with the current notification milestone, transmit a message to the line servers instructing the line servers to begin assigning the next quota of the plurality of quotas associated with the current notification milestone, if all of the lines are associated with the current quota, the next quota being smaller than the current quota, and transmit to the line servers a message instructing that one or more of the lines associated with the previous quota should renegotiate their respective quotas to the current quota, if there are lines associated with the previous quota.

In one embodiment, the one or more line servers are further configured to, receive a request from the lines within the group requesting the new quota allocation; and transmit a message to the lines within the group requesting the new quota allocation indicating that the lines have been reallocated an amount of service units equal to the current quota.

In one embodiment, the one or more line servers are further configured to, receive a request from the lines within the group requesting the new quota allocation; allocate an amount of service units equal to the next quota to the lines within the group requesting the new quota allocation, if the group server instructs the line server to assign the next quota; and force the lines within the group associated with the previous quota to renegotiate their respective quotas with the line server, if the group server instructs the line server to renegotiate the assigned quota with the lines.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the embodiments and wherein:

FIG. 1 illustrates an example of an online charging system configured to serve a group of users according to example embodiments;

FIG. 2 illustrates a group server, a line server and a gateway according to an example embodiment;

FIG. 3 illustrates a signaling diagram illustrating an exchange of signaling messages in an online charging system according to an example embodiment;

FIG. 4 illustrates a usage block allocation method used by a group server to regulate a user group's consumption of service units according to an example embodiment;

FIG. 5 illustrates an allocation method used by a group server to regulate a user group's consumption of service units according to an example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium, such as a non-transitory storage medium. A processor(s) may perform the necessary tasks.

Specific structural and functional details disclosed herein are merely representative for purposes of describing example embodiments. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be any non-transitory storage medium such as magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

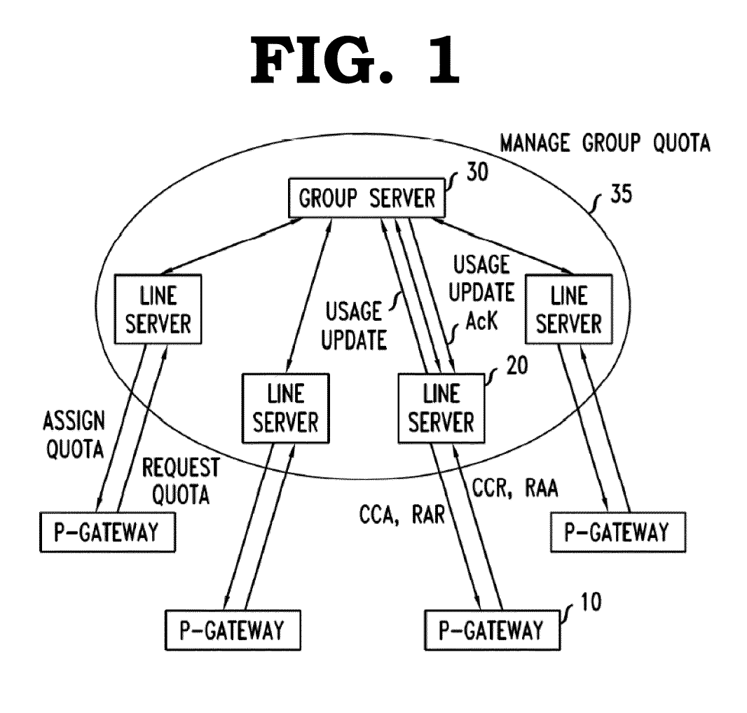

FIG. 1 illustrates a online charging system configured to serve a group of users.

As shown in FIG. 1, an online charging system (OCS) 35 includes a group server 30 connected to a plurality of line servers 20. Each of the line servers 20 is connected to a gateway 10, for example a packet data network (PDN) gateway (P-gateway or PGW). The gateway 10 effectuates communication between the line server 20 and user equipment (UE), served by the line server 20.

The group server 30 and the line servers 20 can regulate the usage of service units by a group of lines through the transmission of messages therebetween.

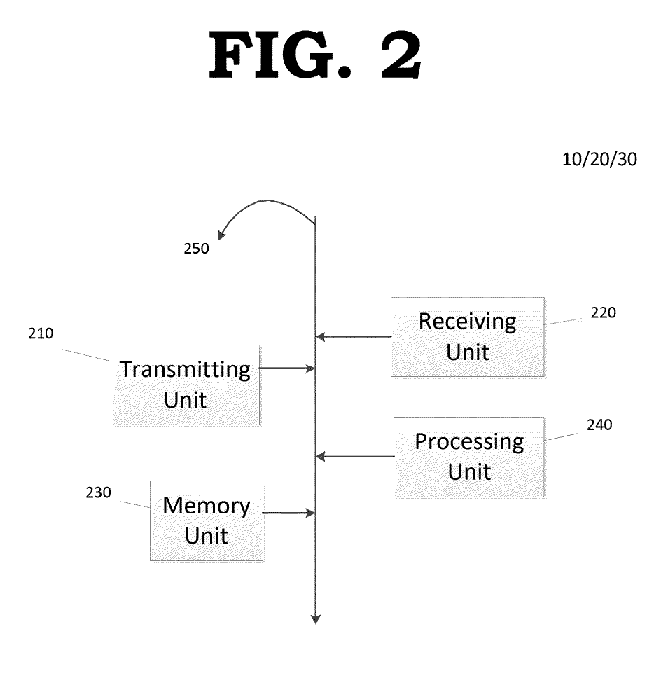

FIG. 2 illustrates a group server, a line server and a gateway according to an example embodiment. It should be also understood that each of the gateway 10, line server 20 and group server 30 may include features not shown in FIG. 2 and should not be limited to those features that are shown.

Referring to FIG. 2, each of the gateway 10, line server 20 and group server 30 may include, for example, a transmitting unit 210, a receiving unit 220, a memory unit 230, a processing unit 240, and a data bus 250.

The transmitting unit 210, receiving unit 220, memory unit 230, and processing unit 240 may send data to and/or receive data from one another using the data bus 250.

The transmitting unit 210 is a device that includes hardware and any necessary software for transmitting wireless signals including, for example, data signals, control signals, and signal strength/quality information via one or more wireless connections to other network elements in the online charging system 35.

The receiving unit 220 is a device that includes hardware and any necessary software for receiving wireless signals including, for example, data signals, control signals, and signal strength/quality information via one or more wireless connections to other network elements.

The memory unit 230 may be any device capable of storing data including magnetic storage, flash storage, etc. The memory unit 230 may store information regarding the diameter protocol, total service units allocated to the group and constraints put on this allocation as required by the example embodiments.

The processing unit 240 may be any device capable of processing data including, for example, a microprocessor configured to carry out specific operations based on input data, or capable of executing instructions included in computer readable code. The computer readable code may be stored on, for example, the memory unit 230.

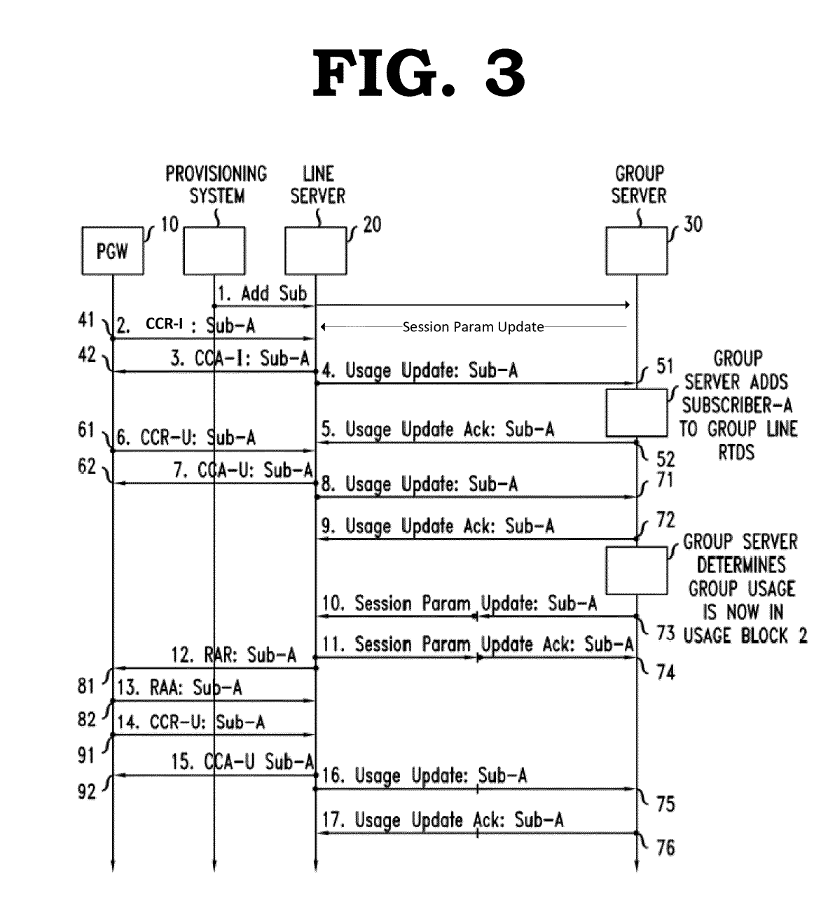

FIG. 3 illustrates a signaling diagram illustrating an exchange of signaling messages in the online charging system 35.

As illustrated in FIG. 3, a line is added by the online charging system 35 by sending an add subscriber notification to the line server 20 and the Group server 30. In response, the Group Server 30 sends a Session Param Update to the Line sever 20 assigning an initial quota of service units to the line. The gateway 10 sends an initial Credit Control Request (CCR) message 41, to line server 20 to request a new session with the line server 20. The line server 20 responds with the Credit Control Answer (CCA) acknowledgement message 42 and assigns the initial quota, instructed by the group server 30, to the gateway 10. When the line has consumed its initial quota, or when the initial quota has timed out, gateway 10 sends an updated CCR message 61 to the line server 20, reporting that the assigned quota has been consumed. The line server 20 responds with a CCA acknowledgement message 62, in which a new quota is assigned to gateway 10.

When the online charging system 35 includes a group server 30 to manage the service units assigned to a plurality of line servers 20 that form a user group, the line server 20 must coordinate the assignment of service units with the group server 30. As shown in FIG. 3, the line server 20 performs this coordination with the group server 30 by sending a series of messages between the line server 20 and the group server 30.

Each time the line server 20 receives a CCR message from its gateway 10, the line server 20 sends the group server 30 a usage update message 51/71/75 reporting the line's current consumption level and the local quota last assigned to the line. The group server acknowledges the usage update message 51 by sending usage update acknowledgement message 52/72/76 back to the line server 20.

When the group server 30 receives a Usage Update, it adds the reported consumption by the line to the known group consumption, and if necessary, it updates the outstanding group quota. The group server 30 then compares the total reported group usage to a usage boundary and on that basis determines whether a new usage boundary needs to be declared. The new usage boundary is declared in a Session Parameter Update message 73 that the group server sends to line servers 20 in its group. In response, each of the line servers 20 send a Session Parameter Update acknowledgement message 74 to the group server 30.

Further, in this embodiment, in response to the Session Parameter Update message 73, the line server 20 sends a Re-Authorization Request (RAR) message 81 to the gateway 10 to request reauthorization of the UE. In response to the RAR message 81, as discussed above, the gateway 10 sends a Re-Authentication Answer (RAA) message 82 and then a Credit Control Request (CCR) message 91 to the line server 20. In response, the line server 20 returns a Credit Control Answer (CCA) message 92 announcing the new line quota to the gateway 10, the new line quota based on the group quota currently assigned to the group. The line server 20 also sends another usage update message 75 to the group server 30 to inform the group server 30 of the current consumption by the line 20, and of the size of the new quota allocated to the line.

The group server 30 can compute the total service units that have been consumed by the group and can maintain a tally of the outstanding quota granted to the group by adding the values received from the respective line servers 20 in the Usage Update messages 51/71/75.

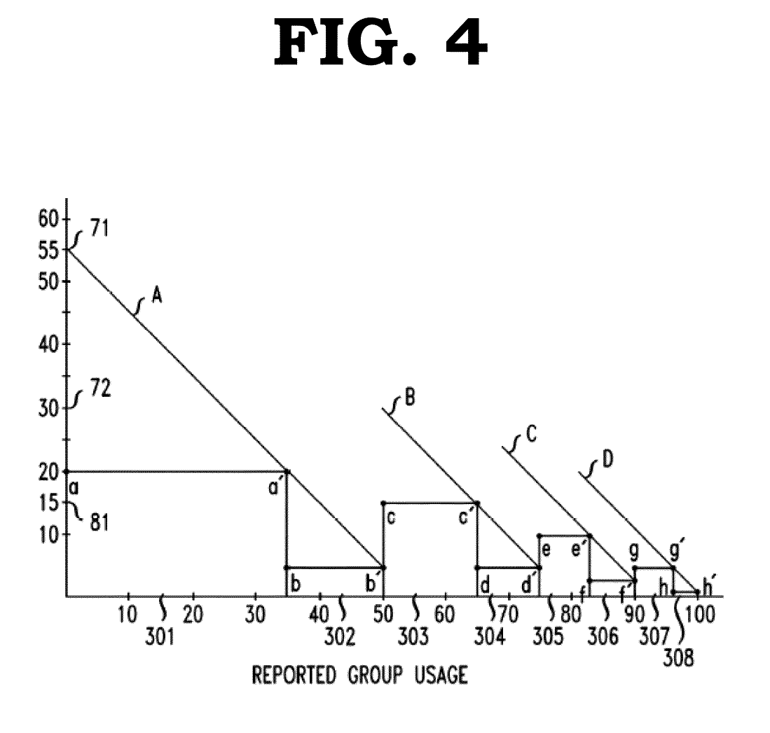

FIG. 4 illustrates a group server's regulation of a user group's consumption of service units via usage blocks according to an example embodiment.

As illustrated in FIG. 4, the horizontal x-axis represents the amount of consumed usage by the group as known by the group server 30, i.e., the total amount of group consumption that has been reported to the group server 30. The vertical y-axis represents the outstanding quota currently assigned to the group. Each line within the group may be assigned a portion of this outstanding quota.

To avoid a user in a group from being surprised that the total service units consumed by the group has reached a total allowance amount for the group, it is desirable for the group server 30 to report the total group consumption when it reaches defined usage milestones (e.g., when reported total group usage equals 50%, 75%, 90%, and 100% of the total group allowance). When reported total service units consumed by the group reaches one of the notification milestones, a subscriber may be notified of the extent to which the total service units have been consumed by the lines.

The group server 30 determines the group consumption via consumption reports contained in the CCR messages reported by the gateways 10 to the line servers 20. However, there may exist a gap in time between these consumption reports and the granting of a new quota via the CCA message, during which other lines in the group can continue to consume their outstanding allowable quota. Therefore, it may be preferable to rein in the outstanding allowable quotas to the lines in the group such that the actual consumption by the group only surpasses the reported usage by at most a level known as an “accuracy requirement”. This ensures that the actual consumption deviates from the notification milestones by at most the accuracy requirement.

In the embodiment illustrated in FIG. 4, the maximum total standby allocation A, illustrated by the diagonal line A, which would stretch from 55% on the y-axis to 55% on the x-axis if extended, therefore, the accuracy requirement is 5% for milestone 50%. Likewise, while for illustrative purposes the accuracy requirements B-D are not extended to the y-axis, the maximum total standby allocation B would stretch from 80% on the y-axis to 80% on the x-axis, therefore, the accuracy requirement is 5% for milestone 75%. Further, the maximum total standby allocation C would stretch from 93% on the y-axis to 93% on the x-axis, therefore, the accuracy requirement is 3% for milestone 90% and the maximum total standby allocation D would stretch from 101% on the y-axis to 101% on the x-axis, therefore, the accuracy requirement is 1% for the notification milestone 100%.

Each of the accuracy requirements defines ranges over which the size of the group quota remains constant, known as “usage blocks”. Each usage block is defined by a point on the y-axis representing the outstanding quota granted to the group and where a line extending from that point intersects a respective maximum total standby allocation.

For example, in the scheme illustrated in FIG. 4, assume that the initial outstanding quota granted to the group, as shown on the y-axis, is 20% of the total service units allowable to the group. Accordingly, the initial quota granted to the group may remain in force until the total reported usage reaches 35%. At that time, because the reported usage is 35% and the accuracy requirement requires that the group only consume at most 5% above the 50% milestone (i.e., at most 55%), the 20% quota assigned to the group cannot be sustained beyond that point in time while continuing to assure that the group does not cross the maximum total standby allocation. As one can recognize, the total reported usage of 35% plus the quota granted to the group of 20% (35%+20%=55%) equals the notification milestone of 50% plus the accuracy requirement of 5% (50%+5%=55%). Accordingly, the potential usage of the group may exceed the maximum total standby allocation if additional quota is allocated to the group above 20% when 35% of the allocated quota has already been used.

In FIG. 4 there are 8 usage blocks stretching from a to a′, b to b′, c to c′, d to d′, e to e′, f to f, g to g′ and h to h′. When the reported usage, as shown on the x-axis, reaches a usage block boundary, represented by the vertical line between two usage blocks, the currently allocated outstanding quota can no longer be maintained if the group is to guarantee staying within the maximum total standby allocation to satisfy the accuracy requirement for the current notification milestone.

When the reported usage, as illustrated on the x-axis, exceeds the maximum total standby allocation A/B/C/D, for example at a point on the x-axis corresponding to an end of the first usage block a′ and a start of the second usage block b, the group server 30 reins in the quota assigned to the group by declaring a new usage boundary via the session parameter update message 73.

The new usage boundary may be defined such that the new quota allocated to the group cannot exceed the maximum total standby allocation to satisfy the accuracy requirement for the current notification milestone. For example, when the allocated quota is 20%, if the reported group usage reaches 35%, which is the current accuracy requirement A at point a′, the quota allocated to the group of lines drops from 20% to 5%, thus making sure that the maximum allocated quota can only reach 55%.

As discussed above, in the embodiment illustrated in FIGS. 3 and 4, because the system is designed to maximize the quota allocation to the lines, a policy violation may occur if the outstanding quota is not reallocated, when the reported usage exceeds the current accuracy requirement A/B/C/D. Therefore, in the embodiment illustrated in FIGS. 3 and 4, to force the lines to renegotiate their quotas to smaller ones, RAR messages 81 are sent by all line servers 20 of the group to their associated gateways 10 every time a new usage block is declared by the group server 30. During this renegotiation process, both RAR/RAA as well as CCR/CCA message pairs must be exchanged. If there exists many lines within a group, this may be inefficient. However, the total amount of messaging can be reduced, and network performance can thereby be improved, if quotas are reallocated to the lines in a different manner.

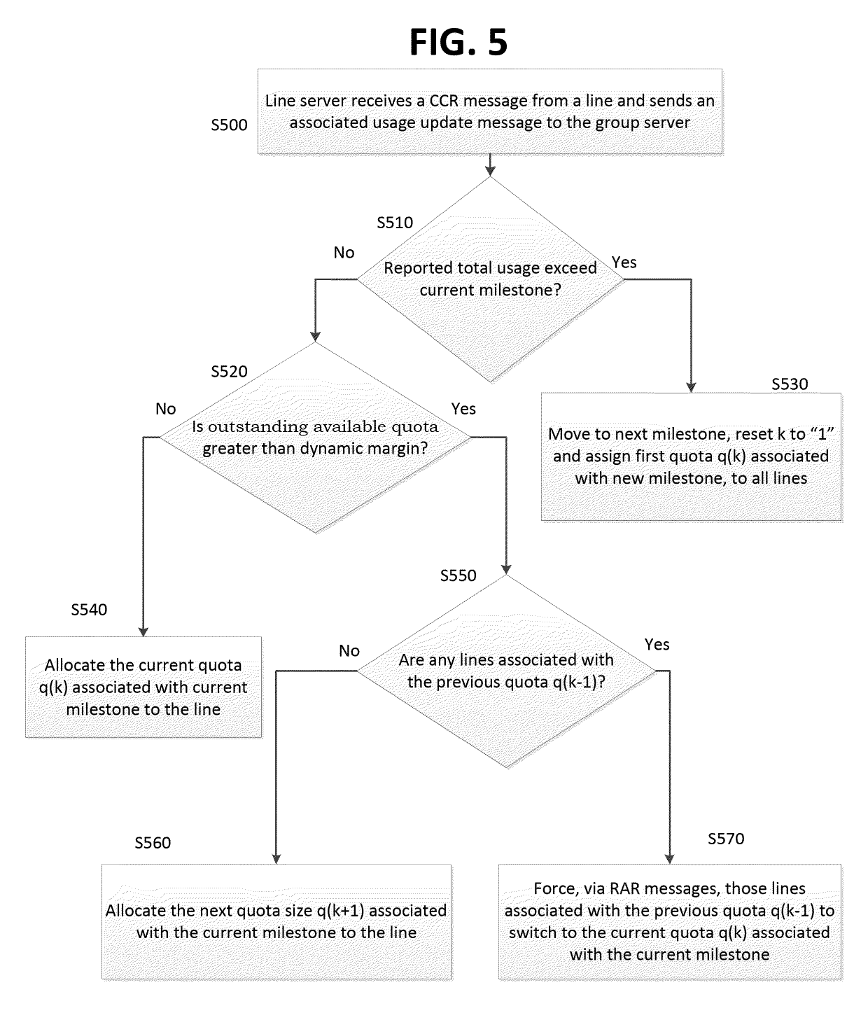

FIG. 5 illustrates a flow chart of an allocation method used by a group server to regulate a user group's consumption of service units according to an example embodiment.

As illustrated in FIG. 5, rather than reallocate the outstanding quota to the group based on a predefined boundary of the reported usage, the reallocation is based on a usage pattern that may be updated in a manner described herein.

The reallocation is such that the quota size is reduced before the reported usage plus the outstanding quota (known as the total allocation) exceeds a maximum total standby allocation to satisfy an accuracy requirement for a current notification milestone. Therefore, because the quotas are reduced before the reported usage plus the outstanding quota exceeds the maximum total standby allocation, lines may be assigned new quotas, when their current quotas are exhausted (i.e., “passively”), via the CCR/CCA message pairs and avoid forcing the lines to renegotiate their quotas via transmission of the RAR/RAA message pairs. The reassignment prior to exceeding the maximum total standby allocation is achieved by creating a “margin” B(x) between the total allocated service units and the maximum total standby allocation and assigning different quotas Q associated with the current notification milestone to the lines. More specifically, for any particular milestone that the line server 20 is currently operating within, the line server 20 may allocate one of a K quotas q(k) to lines as they request a new quota allocation, where each quota size q(k) within the index K from 1 to k

As illustrated in FIG. 5, in step S500 the gateway 10 sends a CCR message to the line server 20 indicating that the gateway 10 requests an assignment or reassignment of service units. In response, the line server 20 sends an associated usage update message to the group server 30 reporting the line's current consumption level and the local quota last assigned to the line.

In step S510, the group server 30 determines whether the total reported usage exceeds a current notification milestone that the group is operating within, where each notification milestone is associated with K different quotas q(k).

In more detail, the group server 30 determines whether the usage reported by the group, as shown on the x-axis, for the group exceeds the current notification milestone (e.g. the 50%, 75%, 90%, or 100% milestone).

If in step S510, the group server 30 determines that the total reported usage exceeds the current notification milestone, the group server proceeds to step S530. In step S530, the group server 30 moves all the lines of the group to the next notification milestone, resets a quota index k to 1 and assigns the initial quota q(k), where k=1, associated with this next notification milestone to all of the lines in the group.

If in step S510, the group server 30 determines that the total reported usage does not exceed the current notification milestone, the group server 30 stays within the current notification milestone and proceeds to step S520. In step S520, the group server 30 determines whether the outstanding available quota for the group is greater than a margin B_k(x) assigned to the group for the current quota index k.

The margin B_k(x) is a margin of safety, assigned to the current quota index k, located a dynamic gap G_k below the maximum total standby allocation M which satisfies the accuracy requirement for the current notification milestone. The margin B_k(x) increases for each consecutive value of the quota index k such that the last value of the margin B_(k+1)(x) is equal to the maximum standby allocation M for all values of the reported group usage x, in other words, B_{—}1(x)<B_{—}2(x)< . . . B_k(x)<B_k+1(x)=M(x), for all values of x.

An example of determining the dynamic gap G_k below the maximum total standby allocation M to satisfy the accuracy requirement for the current notification milestone may be by using a percentage gap, such that the dynamic gap G_k is a fraction (percentage) of the maximum total standby allocation M to satisfy the accuracy requirement for the current notification milestone. In such a case the margin below the maximum total standby allocation to satisfy the accuracy requirement for the current notification milestone may be calculated as:

B_{—}k(x)=(1−G_{—}k)*M(x) (1)

where B_k is the margin for the current quota index k, G_k is the dynamic gap for the current quota index k, and M(x) is the maximum total standby allocation to satisfy the accuracy requirement for the current notification milestone at a particular reported group usage x.

Another example of determining the dynamic gap G_k below the maximum total standby allocation M to satisfy the accuracy requirement for the current notification milestone may be by using a fixed gap based on a constant C_k. In such a case the margin below the maximum total standby allocation to satisfy the accuracy requirement for the current notification milestone may be calculated as:

B_{—}k(x)=M(x)−C_{—}k (2)

where B_k is the margin for the current quota index k, M(x) is the maximum total standby allocation to satisfy the accuracy requirement for the current notification milestone at a particular reported group usage x, and C_k is a constant for the current quota index such that 0≦C≦1. Further, the constants C_k and G_k may be defined differently for each value of the quota index k within the index K.

The margin B_k(x) may vary to ensure that an amount that the variable margin B_k(x) is below the maximum total standby allocation M(x) decreases as the value k of the quota index K increases. For example, the margin B_K(x) may vary based on either equation (1) or equation (2) where dynamic gap G_k(x) varies such that G_{—}1≧G_{—}2≧ . . . ≧G_k and the constant C_k varies such that C_{—}1≧C_{—}2≧ . . . ≧C_k for increasing values of the quota index k within the index K.

If in step S520, the group server 30 determines that the outstanding available quota for the group is not greater than the margin B, then group server 30 proceeds to step S540. In step S540, the group server 30 instructs the line server 20 to continue allocating the current quota q(k) that is associated with the current notification milestone that the group is operating within. In response, the line server 30 sends a CCA message to the gateway 10 to assign the current quota of service units q(k) to the gateway 20. Thereafter, the gateway 10 proceeds with supporting its associated line using the newly assigned current quota q(k).

If in step S520, the group server 30 determines that the outstanding available quota for the group is greater than the margin B_k(x), then group server 30 proceeds to step S550.

Different lines within a group may consume a different amount of resources. For example a group may have “power users” that consume a number of service units and “casual users” who consume a lesser number of service units. Therefore, while a majority of the lines in a group may have already consumed their quota and be operating under a current quota q(k) that is less than a previous quota q(k−1), other lines in the group may still be operating under a previous quota assignment, such as q(k−1), which is greater than the quota q(k) that is currently being allocated. Therefore, in step S550, because the group server 30 has determined that the outstanding available quota for the group is greater than the margin while not violating the maximum total standby allocation, the group server 30 determines if any lines associated with the group are still assigned the previous quota q(k−1), which is greater than the current quota q(k).

If in step S550, the group server 30 determines that there are no lines within the group that are still associated with the previous quota q(k−1), then group server 30 proceeds to step S560. In step S560, the group server 30 instructs the line server 20 to begin allocating the next quota q(k+1), that is smaller than the current quota q(k). The line server 20 may begin to allocate the next quota q(k+1) when the P-GW sends a CCR-u message after an associated line has consumed its current quota q(k). In response, the line server 20 sends a CCA message to the gateway 10 to assign the next quota of service units q(k+1) to the gateway 10. Thereafter, the gateway 10 proceeds with supporting its associated line using the newly assigned quota q(k+1). Therefore, the group can remain under the margin without sending any RAR/RAA messages pairs.

If in step S550, the group server 30 determines that there exists lines within the group that are still associated with the previous quota q(k−1), then group server 30 proceeds to step S570. As discussed above, assignment of quotas is such that the group server 30 assigns progressively smaller quotas, therefore the previous quota q(k−1) is greater than the current quota q(k). Therefore, in step S570, the group server 30 instructs the line server 20 to force those lines associated with the previous quota q(k−1) to switch to the current quota q(k) that is associated with the current notification milestone. Namely, the group server 30 forces the slower casual users to give up their allocation and request a smaller allocation. Accordingly, the group can remain under the margin without sending RAR/RAA messages pairs to all of the lines by only sending RAR/RAA message pairs to lines determined to have the previous quota q(k−1).

While example embodiments have been particularly shown and described, it will be understood by one of ordinary skill in the art that variations in form and detail may be made therein without departing from the spirit and scope of the claims.

We claim:

1. A group server configured to maintain an outstanding quota granted to a group of lines at a variable margin at at most a maximum total standby allocation to ensure a group data usage of the group surpasses a current notification milestone by at most an accuracy requirement associated with the current notification milestone, the group server comprising:
a processor configured to,
update a tally of the group data usage based on a usage update message,
allocate, to lines within the group requesting a new quota allocation, a current quota of a plurality of quotas associated with the current notification milestone, in response to the tally of the group data usage plus the outstanding quota being within the variable margin, and
allocate, to lines within the group requesting a new quota allocation, a next quota of the plurality of quotas, in response to the tally of the group data usage plus the outstanding quota exceeding the variable margin.

2. The group server of claim 1, wherein the processor allocates the current quota and the next quota without forcing the lines to renegotiate their respective quotas, in response to the group data usage being within the current notification milestone.

3. The group server of claim 1, further comprising:
a receiver configured to receive the usage update message; and
a transmitter configured to transmit instruction regarding quota allocations.

4. The group server of claim 1, wherein the next quota is smaller than the current quota.

5. The group server of claim 1, wherein the processor is further configured to,
determine if the group data usage exceeds the current notification milestone; and
reset the current quota for the group to a first quota of a plurality of quotas associated with a next notification milestone, in response to the group data usage being determined to have exceeded the current notification milestone.

6. The group server of claim 5, wherein when the processor determines that the group data usage is within the current notification milestone then the processor is further configured to,
determine if the outstanding quota is greater than the variable margin; and
instruct a transmitter to transmit a message indicating that allocation of the current quota associated with the current notification milestone should be maintained, in response to the outstanding quota being determined to be within the variable margin.

7. The group server of claim 5, wherein when the processor determines that the group data usage is within the current notification milestone then the processor is further configured to,
determine if the outstanding quota is greater than the variable margin; and
in response to the outstanding quota being determined to be greater than the variable margin,
determine if any of the lines in the group of lines are associated with a previous quota of the plurality of quotas associated with the current notification milestone,
transmit a message instructing assignment of the next quota of the plurality of quotas associated with the current notification milestone, in response to determining that all of the lines are associated with the current quota, the next quota being smaller than the current quota, and
transmit a message instructing that one or more of the lines associated with the previous quota should renegotiate their respective quotas to the current quota, in response to determining that there are lines associated with the previous quota.

8. The group server of claim 1, wherein the processor is further configured to vary the variable margin such that an amount the variable margin is below the maximum total standby allocation decreases for each consecutive quota allocation from the plurality of quotas.

9. A method of maintaining, by a group server, an outstanding quota granted to a group of lines at a variable margin at at most a maximum total standby allocation to ensure a group data usage of the group surpasses a current notification milestone by at most an accuracy requirement associated with the current notification milestone, the group of lines connected to the group server via a line server, the method comprising:
updating a tally of the group data usage based on a usage update message;
allocating, to lines within the group requesting a new quota allocation, a current quota of a plurality of quotas associated with the current notification milestone, in response to the tally of the group data usage plus the outstanding quota being within the variable margin; and
allocating, to lines within the group requesting a new quota allocation, a next quota of the plurality of quotas, in response to the tally of the group data usage plus the outstanding quota exceeding the variable margin.

10. The method of claim 9, wherein the next quota is smaller than the current quota.

11. The method of claim 9, wherein the method further comprises:
determining if the group data usage exceeds the current notification milestone; and
resetting the current quota for the group to a first quota of a plurality of quotas associated with a next notification milestone, in response to the group data usage being determined to have exceeded the current notification milestone.

12. The method of claim 11, wherein when the determining determines that the group data usage is within the notification milestone, then the method further comprises:
determining if the outstanding quota is greater than the variable margin; and
transmitting a message indicating that allocation of the current quota associated with the current notification milestone should be maintained, in response to the outstanding quota being determined to be within the variable margin.

13. The method of claim 11, wherein when the determining determines that the group data usage is within the notification milestone, then the method further comprises:
determining if the outstanding quota is greater than the variable margin; and
in response to the outstanding quota being determined to be greater than the variable margin then,
determining if any of the lines in the group of lines are associated with a previous quota of the plurality of quotas associated with the current notification milestone,
transmitting a message instructing assignment of the next quota of the plurality of quotas associated with the current notification milestone, in response to determining that all of the lines are associated with the current quota, the next quota being smaller than the current quota, and
transmitting a message instructing that one or more of the lines associated with the previous quota should renegotiate their respective quotas to the current quota, in response to determining that there are lines associated with the previous quota.

14. The method of claim 11, further comprising:
varying the variable margin such that an amount the variable margin is below the maximum total standby allocation decreases for each consecutive quota allocation from the plurality of quotas.

15. A system to manage quota allocation, the system comprising:
a group server and one or more line servers,
the group server configured to maintain an outstanding quota granted to a group of lines at a variable margin at at most a maximum total standby allocation to ensure a group data usage of the group surpasses a current notification milestone by at most an accuracy requirement associated with the current notification milestone, the group server including,
a group processor configured to,
update a tally of the group data usage based on one or more usage update messages received from the one or more line servers, and
instruct the line servers to allocate an assigned quota to lines within the group requesting a new quota allocation, the assigned quota being a current quota of a plurality of quotas associated with the current notification milestone in response to the tally of the group data usage plus the outstanding quota being within the variable margin, and the assigned quota being a next quota of the plurality of quotas in response to the tally of the group data usage plus the outstanding quota exceeding the variable margin; and
the one or more line servers configured to service the lines, each line server including,
a line processor configured to allocate the assigned quota to the lines within the group requesting the new quota allocation.

16. The system of claim 15, wherein the group processor is further configured to,
determine if the group data usage exceeds the notification milestone; and
reset the current quota for the group to a first quota of a plurality of quotas associated with a next notification milestone, in response to the group data usage being determined to have exceeded the current notification milestone.

17. The system of claim 16 wherein the group processor is further configured to, when the group processor determines that the group data usage is within the notification milestone,
determine if the outstanding quota is greater than the variable margin; and
in response to the outstanding quota being determined to be within the variable margin,
instruct a transmitter to transmit a message to the one or more line servers indicating that allocation of the current quota associated with the current notification milestone should be maintained.

18. The system of claim 16, wherein the group processor is further configured to, when the group processor determines that the group data usage is within the notification milestone,
determine if the outstanding quota is greater than the variable margin; and
in response to the outstanding quota being determined to be greater than the variable margin,
determine if any of the lines in the group of lines are associated with a previous quota of the plurality of quotas associated with the current notification milestone,
transmit a message to the line servers instructing the line servers to begin assigning the next quota of the plurality of quotas associated with the current notification milestone, in response to determining that all of the lines are associated with the current quota, the next quota being smaller than the current quota, and
transmit to the line servers a message instructing that one or more of the lines associated with the previous quota should renegotiate their respective quotas to the current quota, in response to determining that there are lines associated with the previous quota.

19. The system of claim 16, wherein the one or more line servers are further configured to,
receive a request from the lines within the group requesting the new quota allocation; and
transmit a message to the lines within the group requesting the new quota allocation, the message indicating that the lines have been reallocated an amount of service units equal to the current quota.

20. The system of claim 17, wherein the one or more line servers are further configured to,
receive a request from the lines within the group requesting the new quota allocation;
allocate an amount of service units equal to the next quota to the lines within the group requesting the new quota allocation, if the group server instructs the line server to assign the next quota; and
force the lines within the group associated with the previous quota to renegotiate their respective quotas with the line server, if the group server instructs the line server to renegotiate the assigned quota with the lines.
